(19) United States
(12) Patent Application Publication
(10) Pub. No.: US 2006/0208523 A1
(43) Pub. Date: Sep. 21, 2006

(54) Device for locking a filler neck compartment cover and mehtod of mounting the locking device

(75) Inventor: Harald Georgesohn, Althengstett (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/533,780

(22) PCT Filed: Oct. 13, 2003
(86) PCT No.: PCT/EP03/11297

§ 371 Date: Feb. 26, 2006

(51) Int. Cl. B62D 25/00

(52) U.S. Cl. 296/97.22

(57) ABSTRACT

In a locking device for locking a filler neck compartment cover of a vehicle, which can be moved into an open position and into a closed position, a locking element is provided for blocking the filler neck compartment cover in the closed positions and a servo drive is provided for displacing the locking element from a release position into a blocking position. The locking device is designed as a preassembled, modular unit and can be fastened in an edge region of a mounting opening provided in a body part and serves to house the filler neck compartment. At least one retaining groove, which can be pushed onto a retaining flange, is located in or on the mounting opening.

### BACKGROUND AND SUMMARY OF THE INVENTION

This invention relates to a locking device for locking a filler neck compartment cover, to a method of mounting a locking device, and to an arrangement of a locking device on a vehicle.

Locking devices of the type discussed here are known (German document DE 196 12 098 A1). They are used for locking a movable filler neck compartment cover, for example a tank flap, in a closed position in which the filler neck compartment cover covers a mounting opening in a body part of a vehicle. The known locking device has a locking element for blocking the filler neck compartment cover, a servo drive for displacing the locking element and also a guide body for the locking element that is fastened to a wall of the mounting opening. The servo drive and the locking element are arranged behind a side wall of the vehicle, the servo drive being located at a position which is inaccessible from the outside via the mounting opening and is fastened to a wall of a wheel house. Access to the servo drive or to its mounting location is only possible from another position. The operation of mounting the locking device is correspondingly time-consuming and thus expensive.

The object of the invention is to provide a locking device for which mounting on the vehicle requires only a small amount of time and can preferably be carried out simply. A further aim of the invention is to specify a method of mounting the locking device on the vehicle in a time-saving manner.

To achieve the object, a locking device is designed as a preassembled, modular unit and can be fastened in the edge region of a mounting opening provided in a body part. The locking device is thus assembled before being mounted on the vehicle, so that fitting it on the vehicle itself requires only a small amount of time, since the locking device is built up as one part and it is possible to gain access to the mounting point on the vehicle via the mounting opening. Also advantageous are the improved ergonomics of the mounting operation over that employed in known locking devices.

In its simplest embodiment, the locking device may be designed in such a way that the locking element interacts directly with a mating element arranged on the filler neck compartment cover or formed thereon so as to block the filler neck compartment cover arranged in the closed position against opening.

Preference is given to an exemplary embodiment in which the locking device has an engagement opening for a mating element on the filler neck compartment cover that interacts with the locking element. When the filler neck compartment cover is arranged in the closed position, the mating element engages in the engagement opening and can be blocked therein by means of the locking element. The engagement opening ensures exact alignment of the mating element relative to the locking element and thus improves the operational reliability of the locking device.

In a preferred embodiment, the locking device comprises a filler neck compartment cover lifting means which comprises a push-push mechanism whose operating principle takes a similar form for example to the retraction and extension of ballpoint pen cartridges. The structure and operation of such a mechanism are generally known, so that the text below will only detail its mode of operation but not its construction. It will be assumed that the filler neck compartment cover is designed as a pivotable tank flap and is situated in the closed position. By applying pressure to the tank flap, the push-push mechanism is released and thus assists the pivoting of the tank flap in the direction of its open position through a certain angular range. In other words, the tank flap is raised at its movable end at least to such an extent that it can be gripped from behind by an operator and easily opened. When the tank flap is pivoted from the open position into the closed position, the tank flap is pivoted beyond its closed position, an operation also referred to as “overpushing”, which results in the push-push mechanism being locked. The filler neck compartment cover lifting means is particularly advantageous when, in its closed position, the tank flap closes flush with the outside of the vehicle and there is no possibility of gripping it from behind.

Particular preference is given to an exemplary embodiment of the locking device in which the servo drive and the filler neck compartment cover lifting means are themselves each designed as modular units. These are connected to one another to form a single unit prior to mounting the locking device. The advantage with this is that it is not necessary to replace both units if one of the units is defective. The two units are preferably detachably connected to one another, for example by screwing, so that they can be easily separated from one another.

Preference is also given to an exemplary embodiment of the locking device that is distinguished by at least one retaining groove which can be pushed onto a retaining flange, the retaining flange being located in or on the mounting opening. This configuration ensures that the locking device can be mounted exactly and in a reproducible manner on the body part. The retaining flange and the retaining groove are preferably matched to one another in such a way that, when pushing on the locking device, a clamping connection is formed which fixes the locking device to the body part in a positionally secure manner. Further fastening means may preferably be dispensed with, i.e. the above-described groove/flange connection is the one and only fastening point between the locking device and the body part before the filler neck compartment is fitted into the mounting opening and fastened therein.

According to a development of the invention, the retaining groove is provided on a housing of the filler neck compartment cover lifting means. The housing is preferably made of plastic, so that the retaining groove can be formed on the housing in a simple manner during the production thereof.

In a particularly advantageous exemplary embodiment of the locking device, the filler neck compartment cover lifting means has at least two retaining webs arranged at a distance from one another, each of the retaining webs having a retaining groove. A plurality of groove/ flange connection points improve the retention of the locking device on the body part and may, when arranged suitably relative to one another, prevent twisting or tilting of the locking device prefixed in the mounting opening. The retaining webs are preferably formed in one piece with the housing.

Preference is also given to an exemplary embodiment of the locking device that is distinguished in that, when in the mounted state, the filler neck compartment, that is to say a section of the filler neck compartment, engages into the free space between the retaining webs, making it possible to achieve exact alignment of the filler neck compartment with respect to the mounting opening. The filler neck compartment itself is fastened either to the filler neck compartment cover lifting means or to the body part or to the filler neck compartment cover lifting means and to the body part. The filler neck compartment and the locking device are preferably fixed to the body part using one and the same fastening means. For this purpose, use may be made for example of screws which are fitted at a suitable location within the mounting opening.

Preference is also given to an exemplary embodiment of the locking device in which a guide for the locking element is provided on the servo drive. The locking element is preferably held captively on the servo drive, although being able to move to and fro. If the locking element performs a linear movement during its displacement between the release and blocking position, the guide may in a simple form be formed by a passage opening which is preferably provided in a section of a housing of the servo drive.

Further advantageous exemplary embodiments of the locking device result from combinations of the claimed features.

In a first step of one proposed method, the completely assembled locking device is introduced into the mounting opening from the outside and is connected to the body part in a force- and/or form-fitting manner, for example just as described above. It is also conceivable for the locking device to be latched with the body part by means of at least one clip-type connection. In a second step, the filler neck compartment is then fitted into the mounting opening from the outside and fastened to the filler neck compartment cover lifting means and/or to the body part.

The subject matter of the invention also relates to an arrangement of the locking device in which, when in the installed state, the locking device is arranged in a region which is accessible from the outside via the mounting opening.

Further advantageous exemplary embodiments of the arrangement result from combinations of the claimed features.

The invention is explained in more detail below with the aid of the drawing figures.

### BRIEF DESCRIPTION OF THE DRAWINGS

FIG. 1 shows a perspective representation of a detail of a body part having a mounting opening for a filler neck compartment;

FIG. 2 shows a perspective representation of an exemplary embodiment of a locking device for a filler neck compartment cover;

FIG. 3 shows a perspective representation of an exemplary embodiment of a filler neck compartment;

FIG. 4A shows the body part with the locking device fitted into the mounting opening;

FIG. 4B shows the body part with the locking device and filler neck compartment fitted into the mounting opening;

FIG. 4C is a perspective representation showing a rear view of the body part with the locking device and filler neck compartment fitted therein;

FIG. 5A is a front view of the locking device according to FIG. 2;

FIG. 5B is a side view of the locking device according to FIG. 2; and

FIG. 5C is a plan view of the locking device according to FIG. 2.

### DETAILED DESCRIPTION OF THE INVENTION

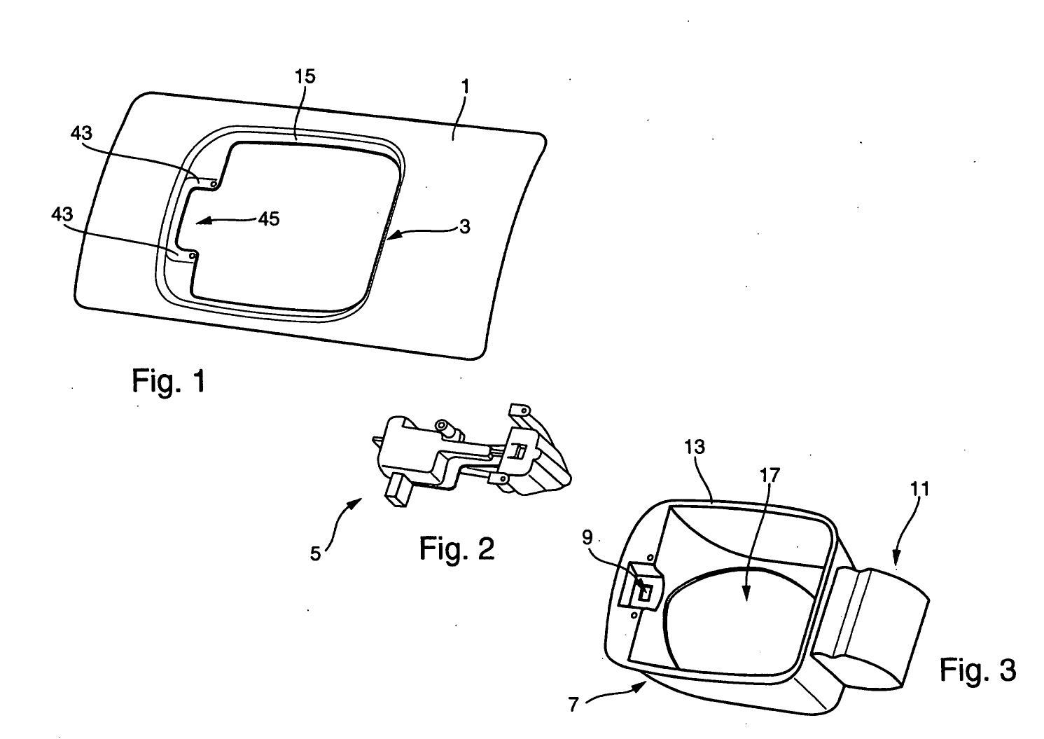

FIG. 1 shows a detail of a body part 1 of a motor vehicle (not shown). The body part 1 may, for example, be formed by a side wall of the vehicle and has a mounting opening 3 which serves to house a locking device 5 represented in FIG. 2 and a filler neck compartment 7 represented in FIG. 3.

Arranged on the pot-shaped filler neck compartment 7, which is made of plastic for example, is a tank flap (not shown in the figures) which can be pivoted about an axis between a closed position and an open position and which serves to cover the mounting opening 3. A mating element, which will not be described in any more detail, provided on the tank flap engages through a passage opening 9 in the filler neck compartment 7 when the tank flap is in the closed position. The bearing point for the tank flap is formed by a thickened portion 11 projecting beyond a side wall of the filler neck compartment 7. At the upper edge of the filler neck compartment 7 there is formed a peripheral flange 13 by way of which the filler neck compartment 7, when in the installed state, rests against a flange 15 which is provided on the mounting opening 3 and is arranged in an inwardly offset manner with respect to the outer face of the body part 1.

At its bottom the filler neck compartment 7 has an opening 17 through which, when the filler neck compartment 7 is in the installed state, engages a fuel filler pipe which projects into the filler neck compartment 7.

The tank flap is assigned an over-center helper spring mechanism (not shown) which keeps the tank flap in the closed or open position. The structure and the operation of the over-center helper spring mechanism is generally known, so that it will not be discussed in further detail here.

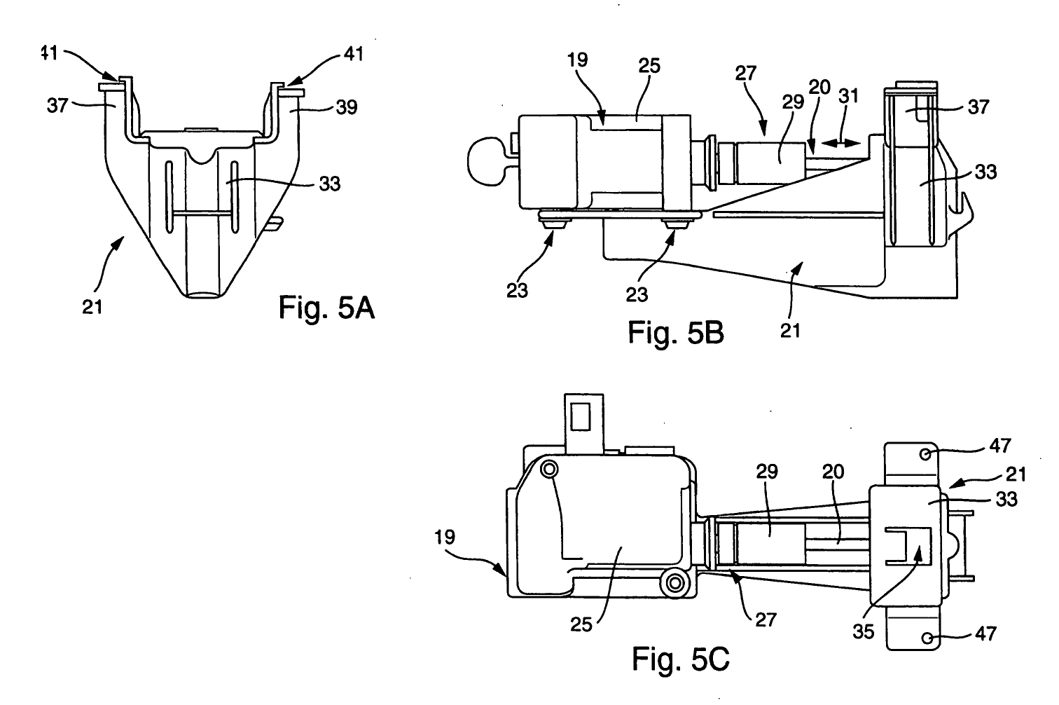

The exemplary embodiment of the locking device 5 that is represented in FIGS. 5A to 5C comprises two separable units, namely a servo drive 19 for displacing a locking element 20 and a filler neck compartment cover lifting means 21, which are connected to one another to form a modular unit with the aid of fastening means 23.

The servo drive 19 comprises a housing 25 which is preferably made of plastic and on which is provided a guide 27 for the pinlike locking element 20. The guide 27 is formed by a section 29 which is integrally molded onto the housing 25 and has a guide opening in which the locking element 20 is guided. The locking element 20 is able to move back and forth in the direction of a double arrow 31 between a release position and a blocking position, something which is achieved by means of a suitable motor, for example a linear motor, accommodated in the housing 25. Alternatively, the locking element may also be displaced by means of a piston/cylinder unit or the like. The servo drive 19 is controlled by a central locking system of the motor vehicle, with the locking element 20 being displaced into the blocking position when closing the motor vehicle and into the release position when the motor vehicle is open.

The filler neck compartment cover lifting means 21 comprises a housing 33, preferably made of plastic, which is provided with a shaft-like engagement opening 35 into which the tank flap mating element engages when the tank flap is arranged in the closed position. Arranged in the housing 33 is a push-push mechanism interacting with the tank flap mating element, as is described above. Also provided in the housing 33 is a passage opening which runs transversely to the direction of insertion of the tank flap mating element into the engagement opening 35 and which emerges laterally into the engagement opening 35. The locking element 20 engages into the passage opening by way of its free end. In the blocking position, the locking element 20 projects into the engagement opening 35 to such an extent that the tank flap mating element is blocked against withdrawal from the engagement opening 35, so that the tank flap is blocked in the closed position and cannot be pivoted into the open position.

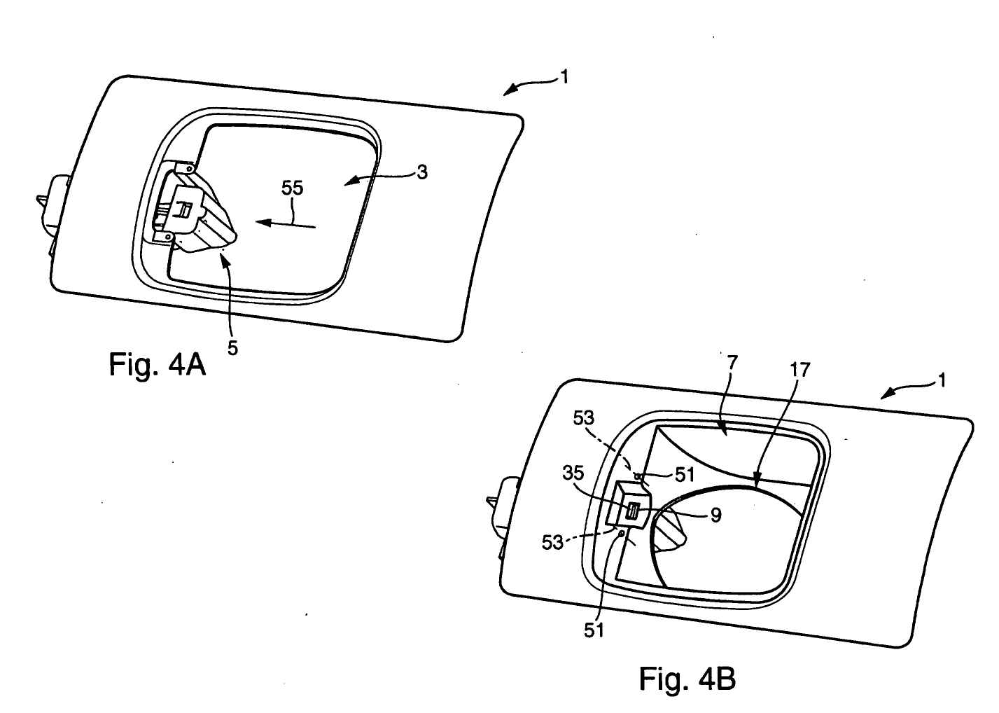

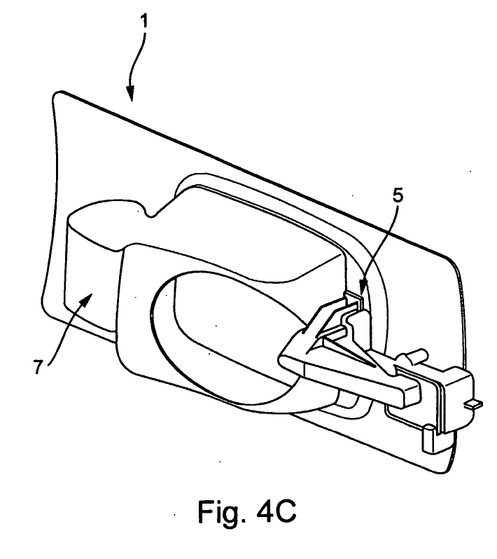

As can be seen from FIG. 5A, two retaining webs 37 and 39 arranged at a distance from one another are formed on the housing 33 and they run substantially parallel to one another and each have a retaining groove 41 formed at their end region. The retaining grooves 41 can be pushed onto retaining flanges 43 on the body part 1. As can be seen from FIG. 1, the retaining flanges 43 are formed on a marginal cutout 45 of the mounting opening 3. The retaining webs 37, 39 are provided with a respective hole 47 which, with the locking device 5 installed, i.e. with the retaining grooves 41 pushed onto the retaining flanges 43, are aligned with passage holes 49 provided on the body part 1. The filler neck compartment 7 also has passage holes 51 which, with the filler neck compartment 7 fitted into the mounting opening 3, are aligned with the passage holes 49 and the holes 47. To fix the locking device 5 and the filler neck compartment 7 in a positionally secure manner with respect to the body part 1, use is made of screws 53, preferably self-cutting screws, which engage through the passage holes 49, 51 and are screwed into the holes 47 in the housing 33. The screws 53 are indicated in FIG. 4B by way of a broken line.

The way in which the locking device 5 and the filler neck compartment 7 are mounted on the body part 1 will be explained in more detail below with reference to FIGS. 4A and 4B. The locking device 5 designed as a modular unit is introduced into the mounting opening 3 from the outside and is pushed onto the retaining flanges 43 at the edge region of the mounting opening 3 by way of its retaining grooves 41, as indicated by an arrow 55 in FIG. 4A, specifically to such an extent that its holes 47 are aligned with the passage holes 49 in the body part 1. In FIG. 4A the locking device 5 is represented in a completely pushed-in or pushed-on position. It is clear that, as seen from the perspective of a viewer looking at the mounting opening 3 from the outside, the locking device 5 is for the most part covered by the body part 1 and only part of the filler neck compartment cover lifting means 21 can still be seen. In a second step, the filler neck compartment 7, if appropriate together with the already preassembled tank flap, is then pivoted into the mounting opening 3 from the outside, its flange 15 being brought into contact with the flange 13 on the mounting opening 13. FIG. 4B shows the filler neck compartment 7 in the correctly fitted position. It can be seen that, in the region of its passage opening 9, which is situated in a position of alignment with the engagement opening 35 of the filler neck compartment cover lifting means 21, the filler neck compartment 7 has a shaped portion which is made to match the free space between the retaining webs 37, 39 and which engages into the free space, which means that the filler neck compartment 7 is aligned in the mounting opening 3 in the desired manner and is secured against twisting. The filler neck compartment 7 is formed in such a way that it substantially completely covers that part of the locking device 5 arranged in the mounting opening 3, so that only that part of the locking device 5 arranged in the overlapping position with the passage opening 9 can still be seen. To complete the mounting work, the filler neck compartment 7 and the locking device 5 are finally screwed to the body part 1 by means of the screws 53.

It remains to be stressed that the servo drive 19 fastened to the filler neck compartment cover lifting means 21 has no dedicated fastening point with the body part 1, but is retained on the body part 1 solely by the filler neck compartment cover lifting means 21 which for its part is connected directly to the body part 1.

Depending on the position of the connections on the servo drive 19 and of the cable guide, the servo drive 19 is connected up to the central locking system and to the power supply of the motor vehicle before fitting the locking device 5 on the body part 1 or thereafter, the connections and the cable guide preferably being arranged or chosen in such a way that connection is possible from the outside via the mounting opening.

FIG. 4C shows the inside of the body part 1 with the locking device 5 and filler neck compartment 7 installed into the mounting opening 3. It can be seen that the locking device 5 rests on or is supported on the inside of the body part 1 by way of the housing 25 of the servo drive 19, as a result of which rattling noises are avoided.

In summary, it remains to be stressed that in the exemplary embodiment described with reference to the figures, all the mounting work required to fit the locking device 5 and the filler neck compartment 7 on the body part 1 can be carried out from the outside via the mounting opening 3, so that good ergonomics of the mounting operation can be ensured. Mounting can therefore be carried out quickly and thus cost-effectively. It is also advantageous that the whole working area can be viewed by the fitter, thus giving a high level of process reliability.

1-9. (canceled)

10. A locking device for locking a filler neck compartment cover of a vehicle that can be moved into an open position and into a closed position, comprising:
a locking element for blocking the filler neck compartment cover in the closed position; and
a servo drive for displacing the locking element from a release position into a blocking position,
wherein the locking device is designed as a preassembled, modular unit which can be fastened in an edge region of a mounting opening provided in a body part of the vehicle, serves to house the filler neck compartment, and has at least one retaining groove which can be pushed onto a retaining flange located in or on the mounting opening.

11. The locking device as claimed in claim 10, wherein the mounting opening has a marginal cutout.

12. The locking device as claimed in claim 11, wherein the retaining flange is formed on the marginal cutout.

13. The locking device as claimed in claim 12, wherein the retaining groove is provided on a housing of a filler neck compartment cover lifting arrangement.

14. The locking device as claimed in claim 13, wherein the filler neck compartment cover lifting arrangement has at least two retaining webs arranged at a distance from one another, and wherein each of the retaining webs has a retaining groove.

15. The locking device as claimed in claim 14, wherein an engagement opening for a mating element on the filler neck compartment cover interacts with the locking element.

16. The locking device as claimed in claim 15, wherein the filler neck compartment cover lifting arrangement comprises a push-push mechanism.

17. The locking device as claimed in claim 16, wherein the servo drive and the filler neck compartment cover lifting arrangement are each designed as a modular unit.

18. The locking device as claimed in claim 16, wherein the servo drive and the filler neck compartment cover lifting arrangement are detachably connected to one another.

19. The locking device as claimed in claim 18, wherein, when in the mounted state, the filler neck compartment engages into a free space between the retaining webs, and wherein the filler neck compartment can be fastened to the filler neck compartment cover lifting arrangement.

20. The locking device as claimed in claim 19, wherein the filler neck compartment can be fastened to at least one of the retaining webs and the body part.
